(19) United States
(12) Patent Application Publication
(10) Pub. No.: US 2006/0164666 A1
(43) Pub. Date: Jul. 27, 2006

(54) Apparatus and method for controlling speed of printing medium supplied to image printing apparatus

(75) Inventor: Young-Sun Chun, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/335,577

(22) Filed: Jan. 20, 2006

(30) Foreign Application Priority Data
Jan. 22, 2005 (KR) 2005-006092

(51) Int. Cl. G06K 15/00

(52) U.S. Cl. 358/1.12

(57) ABSTRACT

Provided is a method and an apparatus for controlling the speed of a printing medium fed to an image printing apparatus. The apparatus includes a compensation waveform storage unit, a compensation delay amount determiner, and a ripple compensator. The compensation waveform storage unit stores a compensation waveform used to compensate for a periodic ripple error of the speed, obtained by analyzing positional information of the printing medium. The compensation delay amount determiner determines a delay amount. The ripple compensator applies the compensation waveform to the printing medium supply device with a delay corresponding to the compensation delay amount to compensate for the ripple error. The print quality is enhanced by uniformly supplying the printing medium to the image printing apparatus by compensating for the periodic ripple error.

### CROSS-REFERENCE TO RELATED PATENT APPLICATION

This application claims the benefit under 35 U.S.C. §119(a) of Korean Patent Application No. 10-2005-0006092, filed on Jan. 22, 2005, in the Korean Intellectual Property Office, the entire disclosure of which is hereby incorporated by reference.

### BACKGROUND OF THE INVENTION

1. Field of the Invention

The present invention relates to a method and an apparatus to control the speed of a printing medium fed to an image printing apparatus. More particularly, the present invention relates to a method and an apparatus for enhancing print quality by uniformly supplying a printing medium to an image printing apparatus by compensating for a periodic speed ripple error caused by characteristics of a motor.

2. Description of the Related Art

Generally, an image printing apparatus prints an image on a printing medium, such as paper, in various ways. Exemplary types of image printing apparatuses include bubble-jet apparatuses, ink-jet apparatuses, electro-photography apparatuses, and heat transfer apparatuses. Many techniques have been proposed to enhance the printing speed, image quality, and image resolution of an image printing apparatus.

When printing is performed by an image printing apparatus, a printing medium is transferred in a perpendicular direction to an operational direction of a printing device, such as a print head or an ink cartridge. In other words, the printing device forms a corresponding image while moving in a horizontal direction while the printing medium moves in a vertical direction.

Therefore, to enhance the quality of a printed image, the position and speed of both the printing device and the printing medium must be accurately controlled. When the position of the printing medium is not accurately controlled, the printed image is misaligned. Furthermore, stripes can appear on the printing medium even when the same image is printed on different printing mediums. These stripes create a banding effect that degrades the print quality.

FIG. 1 depicts a conventional apparatus 100 for controlling the speed of a printing medium supplied to an image printing apparatus.

The apparatus 100 includes an adder 110, a Proportional, Integral, Derivative (PID) controller 120, a printing medium supply mechanism 130, and a differentiator 140. When a speed command is applied, a printing medium is supplied by the printing medium supply mechanism 130. The printing medium supply mechanism 130 can include a motor (not shown), a pulley (not shown), a belt (not-shown), and a driving controller (not shown). The printing medium supply mechanism 130 outputs positional information of the printing medium. The differentiator 140 then differentiates the positional information of the printing medium and generates a signal representative of the medium's speed. The medium speed signal is fed back to the adder I 10 and then applied to the PID controller 120. The PID controller 120 is used to control physical values, such as a response time, a settling time, and a maximum overshoot of the apparatus 100. Thus, by using apparatus 100, the position and speed of the printing medium can be controlled.

The motor, included in the printing medium supply mechanism 130, typically has a plurality of armatures (not shown) which are disposed at a constant distance from each other. The armatures in the motor generate a torque for rotating a shaft of the motor. Since the armatures are not arranged in a continuous manner, a periodic ripple error appears in the output torque. This periodic ripple error is called a cogging torque.

When the motor operates at high speed, the effect due to the cogging torque is negligible, and because of this the ripple error is not compensated for in the conventional apparatus 100. However, it is not easy to compensate for ripple error due to its non-linearity. The PID controller 120 in the apparatus 100 only compensates to reduce a difference between an input speed and an output speed. Therefore, the compensation performance of the conventional apparatus 100 with respect to the periodic ripple error is poor.

Accordingly, there is a need for an improved method and apparatus to accurately control the position of a printing medium supplied to an image printing apparatus, especially by compensating for the cogging torque in order to enhance image quality.

### SUMMARY OF THE INVENTION

An aspect of the present invention is to address at least the above problems and/or disadvantages and to provide at least the advantages described below. Accordingly, an apparatus is provided for controlling a speed of a printing medium supplied to an image printing apparatus by a printing medium supply device. The apparatus comprises a compensation waveform storage unit for storing at least one compensation waveform used to compensate for at least a periodic ripple error of the speed, the periodic ripple error being obtained by analyzing positional information of the printing medium. A compensation delay amount determiner determines at least an amount of delay used in applying the compensation waveform to the printing medium supply device. A ripple compensator applies at least the compensation waveform to the printing medium supply device with at least the determined amount of delay amount in order to compensate for the ripple error. The compensation delay amount determiner determines an optimal compensation delay amount by using a self-learning algorithm that comprises a recursive method. The compensation delay amount determiner comprises an error amount calculator for calculating an amount of cumulative error during one period of the ripple error. A rate of change calculator calculates a rate of change of an output of the error amount calculator. A delay amount learning portion determines a result of an application of a learning constant to the output of the rate of change calculator as an updated compensation delay amount and delivering the updated compensation delay amount to the compensation waveform storage unit. The compensation delay amount determiner further comprises a learning termination preventer for applying a given value to the rate of change calculated by the rate of change determiner when the rate of change remains unchanged, such that the compensation delay amount determiner continues the learning algorithm.

Exemplary embodiments of the present invention also provide a method for controlling a speed of a printing medium supplied to an image printing apparatus by a printing medium supply device. The method comprises measuring a periodic ripple error in the printing medium speed by analyzing positional information of the printing medium. A compensation waveform suitable for compensating for the ripple error is determined. An amount of compensation delay used when applying the compensation waveform to the printing medium supply device is determined. The ripple error is compensated for by applying the compensation waveform to the printing medium supply device with the determined amount of compensation delay. An optimal compensation delay amount is determined by using a self-learning algorithm that uses a recursive method. A cumulative error amount is calculated during one period of the ripple error. A rate of change of the cumulative error amount is calculated, and the compensation delay amount is updated by multiplying the calculated rate of change by a learning constant. Frequency components of the ripple error are analyzed and the analyzed frequency components are multiplied by different weights. Amplitude components of the ripple error are analyzed and different weights are applied to the analyzed amplitude components.

Exemplary embodiments of the present invention preferably provide an apparatus for controlling the speed of a printing medium by accurately compensating for a ripple error generated by a printing medium supply mechanism.

Exemplary embodiments of the present invention also preferably provide a method for controlling the speed of a printing medium by detecting in real time a ripple error and optimally compensating for the ripple error.

According to an aspect of an exemplary embodiment of the present invention, an apparatus and method for controlling a speed of a printing medium are provided, which accurately compensate for a ripple error generated by a printing medium supply mechanism. Thus, since the periodical disturbance of the printing medium speed controlling apparatus is compensated for, the printing quality of an image printing apparatus using the above apparatus is increased.

According to another aspect of an exemplary embodiment of the present invention, a method for controlling the speed of a printing medium is provided by analyzing a ripple error in real time and optimally compensating for the ripple error without the use of complex hardware. In particular, since a low-cost motor can be used as the printing medium supply mechanism and an operation of the motor is robust to a ripple error even at low operation speeds, the rotation speed range of the motor is enlarged. Therefore, the manufacturing cost of the image printing apparatus can be reduced by using lower-cost motors.

Furthermore, a banding effect that degrades the quality of an image printing apparatus operating at a low operation speed, such as with a photo printer, is prevented.

Other objects, advantages, and salient features of the present invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 depicts a conventional apparatus for controlling the speed of a printing medium supplied to an image printing apparatus;

FIG. 2 is a block diagram of an apparatus for controlling the speed of a printing medium according to an exemplary embodiment of the present invention;

FIG. 3 is a block diagram of an apparatus for controlling the speed of a printing medium according to another exemplary embodiment of the present invention;

FIG. 4A shows a periodic ripple error of a speed of a printing medium supplied to an image printing apparatus;

FIG. 4B shows a compensation waveform stored in a compensation waveform storage unit in the printing medium speed controlling apparatus according an exemplary embodiment of the present invention;

FIG. 5 shows a plot for describing a self-learning algorithm used by a delay amount determiner in the apparatus of FIG. 3 according to an exemplary embodiment of the present invention;

FIG. 6 is a flowchart of a method of controlling the speed of a printing medium according to an exemplary embodiment of the present invention; and

FIGS. 7A and 7B depict the speed of printing medium before and after using the method of FIG. 6, respectively.

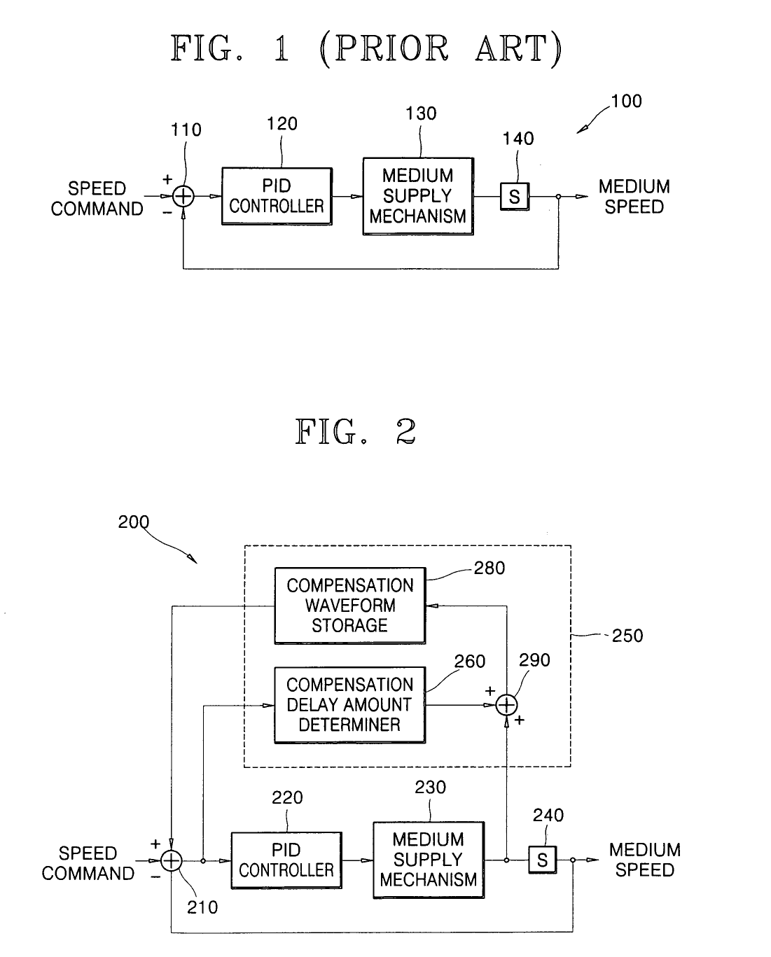

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. FIG. 2 is a block diagram of an apparatus 200 for controlling the speed of a printing medium according to an exemplary embodiment of the present invention.

The apparatus 200 includes an adder 2 1 0, a PID controller 220, a printing medium supply mechanism 230, a differentiator 240, and a ripple error compensator 250. The ripple error compensator 250 includes another adder 290, a compensation delay amount determiner 260 and a compensation waveform storage unit 280.

The ripple error compensator 250 calculates a ripple error using positional information outputted by the printing medium supply mechanism 230. The ripple error is stored in the compensation waveform storage unit 280. The compensation waveform storage unit 280 can determine a compensation waveform for the ripple error in various ways. The degree to which the ripple error is compensated depends on the compensation waveform. In other words, the ripple error is better compensated for, when the compensation waveform is more similar to the ripple error.

The compensation waveform storage unit 280 can determine the compensation waveform by detecting an envelope of the ripple error. Thus, the compensation waveform is generated to have a form corresponding to the maximum amplitude of the ripple error. Accordingly, most components of the ripple error can be removed by applying the compensation waveform with a determined delay, such that the compensation waveform counterbalances the ripple error.

Alternatively, the compensation waveform storage unit 280 can determine the compensation waveform by obtaining the frequency components of the ripple error, and applying different weights to the obtained frequency components. For example, the compensation waveform storage unit 280 can determine the compensation waveform by performing a Fourier transformation on the ripple error to obtain the frequency components, and then apply the largest weight to the largest frequency component. Accordingly, the compensation waveform storage unit 280 determines the compensation waveform based on one or more components of the ripple error to be removed.

It should be understood that the determination of the compensation waveform in the compensation waveform storage unit 280 is given only in an illustrative sense, rather than a restrictive sense. Of course, any other method to determine the compensation waveform can be used.

When the compensation waveform storage unit 280 stores the compensation waveform used to compensate for the ripple error, the compensation delay amount determiner 260 determines a compensation delay amount used when applying the compensation waveform stored in the compensation waveform storage unit 280. The compensation delay amount is a delay between the time when the compensation waveform is used and the time when apparatus 200 outputs a signal. For simplicity, it is assumed that the ripple error and the compensation waveform have the same waveform. It is to be noted that this assumption does not restrict the exemplary embodiments of the present invention as the ripple error and the compensation waveform may be differing waveforms

00361 A ripple error and compensation waveform having the same magnitude and frequency components can be overlapped in various ways. For example, when the ripple error and the compensation waveform are substantially in phase, the ripple error and the compensation waveform are added to each other. In this case, the ripple error increases. On the contrary, when the ripple error and the compensation waveform are out of phase by about 180 degrees, the ripple error is substantially removed. Therefore, the amount of compensation delay can play a role in reducing the ripple error.

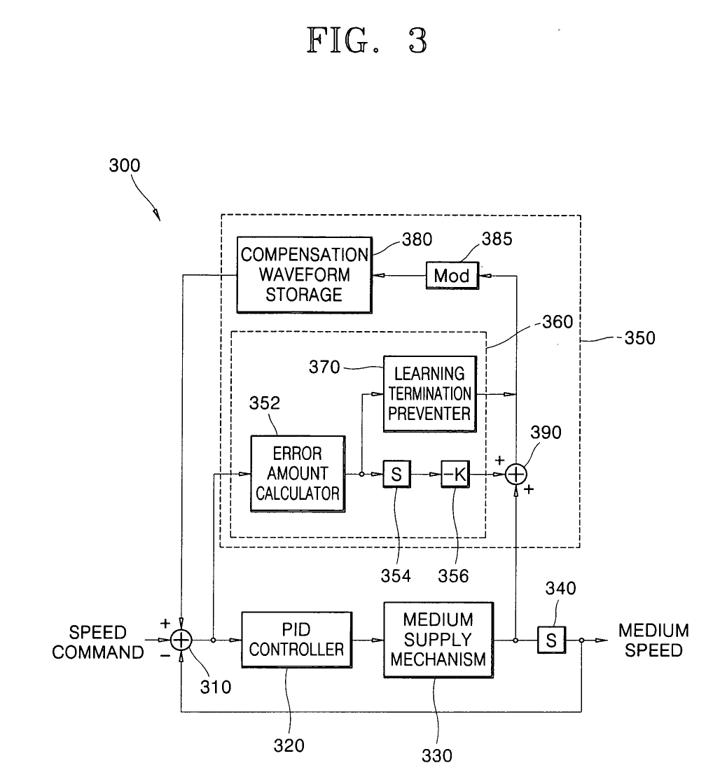

In an exemplary embodiment of the present invention, the compensation delay amount determiner 260 in the apparatus 200 determines the amount of compensation delay using a self-learning algorithm. The configuration and operation of the compensation delay amount determiner 260 using a self-learning algorithm will be explained in detail with reference to FIG. 3.

After the compensation waveform and the compensation delay amount are respectively determined by the compensation waveform storage unit 280 and the compensation delay amount determiner 260, the compensation waveform is applied to the apparatus 200 after the determined delay amount so that the ripple error of the printing * medium supply mechanism 230 is compensated for.

As shown in FIG. 2, the apparatus 200 compensates for the ripple error by using the ripple error compensator 250, and physical values, such as a response time and a maximum overshoot of the printing medium supply mechanism 230, by using the PID controller 220. Therefore, the position and speed of the printing medium supplied by the printing medium supply mechanism 230 can be accurately controlled.

FIG. 3 is a block diagram of an apparatus 300 for controlling the speed of a printing medium according to another exemplary embodiment of the present invention.

The apparatus 300 shown in FIG. 3 includes an adder 310, a PID controller 320, a printing medium supply mechanism 330, a differentiator 340, and a ripple error compensator 350. The ripple error compensator 350 also includes another adder 390, a modulo operator 385, a compensation delay amount determiner 360 and a compensation waveform storage unit 380. The compensation delay amount determiner 360 includes an error amount calculator 352, a rate of change calculator 354, a delay amount learning portion 356, and a learning termination preventer 370.

The configurations and operations of the adder 310, PID controller 320, printing medium supply mechanism 330, differentiator 340, adder 390, and compensation waveform storage unit 380 are similar to those of the adder 210, PID controller 220, printing medium supply mechanism 230, differentiator 240, adder 290, and compensation waveform storage unit 280 shown in FIG. 2, respectively, and explanations thereof are omitted for clarity and conciseness.

The operation of the compensation delay amount determiner 360 in the ripple error compensator 350 will be explained in detail.

The error amount calculator 352 measures an overall error amount generated during one period of the ripple error. Various methods can be used to measure the overall error amount. For example, absolute values of measured errors can be calculated, and the absolute values added to obtain the overall error amount. Alternatively, measured errors can be squared, and the squared values added to obtain the overall error amount. In either way, the error amount calculator 352 obtains the overall error amount for each period. Of course, the methods described above for obtaining the overall error amount are merely exemplary wand any other method for obtaining the overall error amount can be used.

The rate of change calculator 354 compares the error amount outputted from the error amount calculator 352 with a previous error amount and outputs a rate of change of the error amount. Since the rate of change is used to determine an optimal compensation delay amount, the rate of change calculator 354 measures the rate of change of the error amount. The rate of change of error amount outputted from the rate of change calculator 354 is sent to the delay amount learning portion 356. The delay amount learning portion 356 determines the compensation delay amount by using a learning constant to reduce the received rate of change. When the rate of change is smaller than zero, the compensation delay amount is increased, while the compensation delay amount is decreased when the rate of change is greater than zero. In this way, the optimal compensation delay amount is determined.

When the learning constant is higher, the variation of the compensation delay amount increases, and the learning process can be performed rapidly. However, an error generated during the learning process also increases. On the contrary, when the learning constant is small, the variation of the compensation delay amount is small, which leads to a slow learning speed. However, the error during the learning process decreases.

The self-learning algorithm used in the compensation delay amount determiner 360 uses, for example, equation (1) below.

$${x}_{n} = {x}_{n - 1} - k \frac{ⅆ ( error )}{ⅆ x} \\ \qquad ( 1 )$$

According to Equation (1), a new compensation delay amount xₙ can be obtained by subtracting the rate of change d(error)/dx calculated in the rate of change calculator 354 multiplied by the learning constant k from a previous compensation delay amount xₙ₋₁. When the learning constant k is higher, the difference between the previous and new compensation delay amounts increases. Accordingly, the learning speed increases.

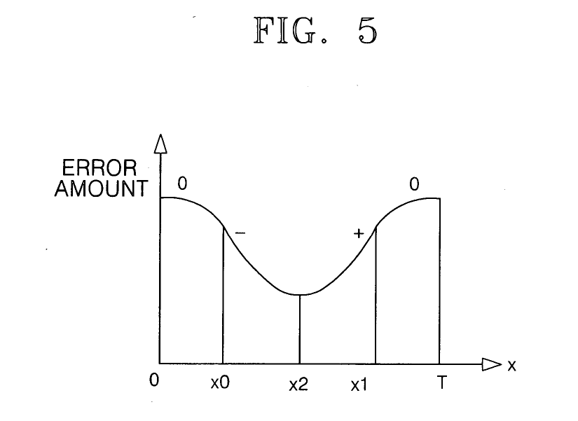

The operations of the rate of change calculator 354 and the delay amount learning portion 356 will be explained in detail with reference to FIG. 5.

The compensation delay amount determiner 360 shown in FIG. 3 includes a learning termination preventer 370. The learning termination preventer 370 prevents the learning process from terminating when the output of the rate of change calculator 354 is zero and the left and right terms in Equation (1) are equal to each other. When the output of the rate of change calculator 354 is equal to zero, the ripple error corresponding to the determined compensation delay amount reaches a minimum or a maximum. Therefore, it is preferable to change the output of the rate of change calculator 354 to a value, other than zero, so that the learning process can continue. Thus, the learning termination preventer 370 replaces a zero rate of change with other value. The operation of the learning termination preventer 370 is also explained in detail with reference to FIG. 5.

As shown in FIG. 3, the apparatus 300 according to an exemplary embodiment of the present invention, can maximize the compensation efficiency by continuously learning the optimal compensation delay via the compensation delay amount determiner 260 and then supplying the learned compensation delay amount to the compensation waveform storage unit 380. Additionally, the apparatus 300 is also robust to non-linear ripple errors.

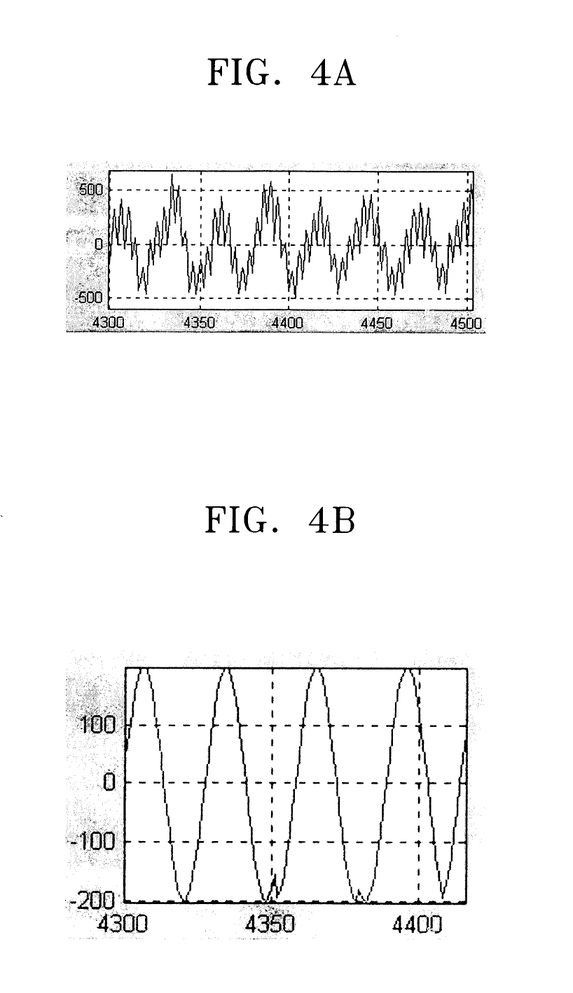

FIG. 4A shows a periodic ripple error of a speed of a printing medium supplied to an image printing apparatus.

In the graph shown in FIG. 4A, the x axis represents the position of a printing medium expressed in a unit of 1/4800 inch, and the y axis represents a ripple error of the printing medium speed expressed in a unit 1/200 mm/sec. As shown in the graph in FIG. 4A, the ripple error includes substantially similar waveforms that are repeated. The compensation waveform for compensating for the ripple error of FIG. 4A is shown in FIG. 4B.

FIG. 4B shows a compensation waveform stored in a compensation waveform storage unit in the apparatus 300 according to an exemplary embodiment of the present invention.

The compensation waveform shown in FIG. 4B is used to reduce the ripple error and has a waveform similar to a sinusoidal waveform. However, this is merely exemplary as other appropriate waveforms can be used as the compensation waveform. Furthermore, the compensation waveform does not have to be explicitly expressed by a mathematical expression. Rather, the compensation waveform can be an array of discrete values, and the array can be stored in a look-up table. The array of discrete values can be repeatedly supplied by the modulo operator 385. The modulo operator calculates a remainder that results from a division of a dividend by a divisor.

FIG. 5 shows a plot for describing a self-learning algorithm used by the compensation delay amount determiner 360 in the apparatus of FIG. 3 according to an exemplary embodiment of the present invention.

The x-axis of the plot of FIG. 5 represents a compensation delay amount, while the y-axis represents the error amount calculated in the error amount calculator 352 of FIG. 3. Assuming that the compensation delay amount is x0, the output of the rate of change calculator 354 in FIG. 3 shows that the rate of change is smaller than zero. Referring to Equation (1), a value greater than x0 is determined as a next value.

When the compensation delay amount is assumed to be x1, the output of the rate of change calculator 354 of FIG. 3 shows that the rate of change is greater than zero. Referring to Equation (1), a value smaller than x0 is determined as the next value.

After repeating the learning process, the compensation delay amount gets close to x2 and the error amount is reduced. However, when the compensation delay amount is zero or T, the rate of change is equal to zero. Although the error amount has its maximum value at zero or T. Zero or T is a doldrums state where the compensation delay amount does not vary any more since the rate of change at those positions is zero. Therefore, the learning termination preventer 370 in FIG. 3 replaces the rate of change with a value other than zero, so that the learning process continues.

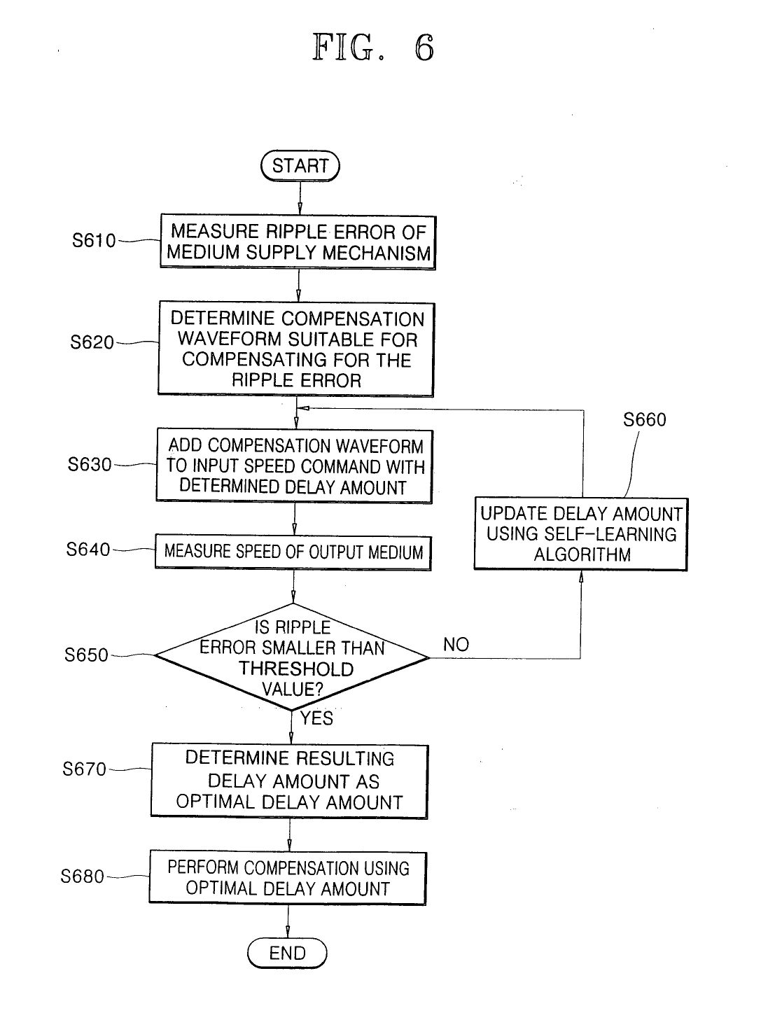

FIG. 6 is a flowchart of a method of controlling the speed of a printing medium according to an exemplary embodiment of the present invention.

First, positional information of a printing medium is analyzed and a periodic ripple error of the printing medium speed is measured in operation S610. By way of example, the ripple error of the printing medium speed can be generated by a cogging torque of a motor, but the ripple error can be generated by any other means. As such, the ripple error generated by other periodic disturbances can be compensated for by the method of an exemplary embodiment of the present invention.

Next, a compensation waveform that is suitable for compensating for the ripple error is determined in operation S620. While the compensation waveform may have a waveform similar to that of the ripple error, the compensation waveform may also be generated by applying different weights on the frequency or amplitude components as described above.

Then, a compensation delay amount used for applying the compensation waveform to a printing medium supply mechanism is determined. The compensation delay amount is determined by using a self-learning algorithm which recursively determines the compensation delay amount to reduce the ripple error. Afterwards, a compensation waveform having a determined delay amount is added to a speed command input in operation S630. Then, the speed of the printing medium according to the inputted speed command is measured in operation S640, and the result is analyzed to determine whether the ripple error is lower than a threshold value in operation S650. When the ripple error is lower than the threshold value the method is stopped. However, when the ripple error is greater than the threshold value, more learning is required, and the compensation delay amount is replaced with a new compensation delay amount in operation S660. Finally, all the above operations are repeated using the new compensation delay amount.

When the self-learning process is finished, the resulting compensation delay amount is determined as an optimal compensation delay amount in operation S670, and a compensation process is performed using the optimal compensation delay amount in operation S680.

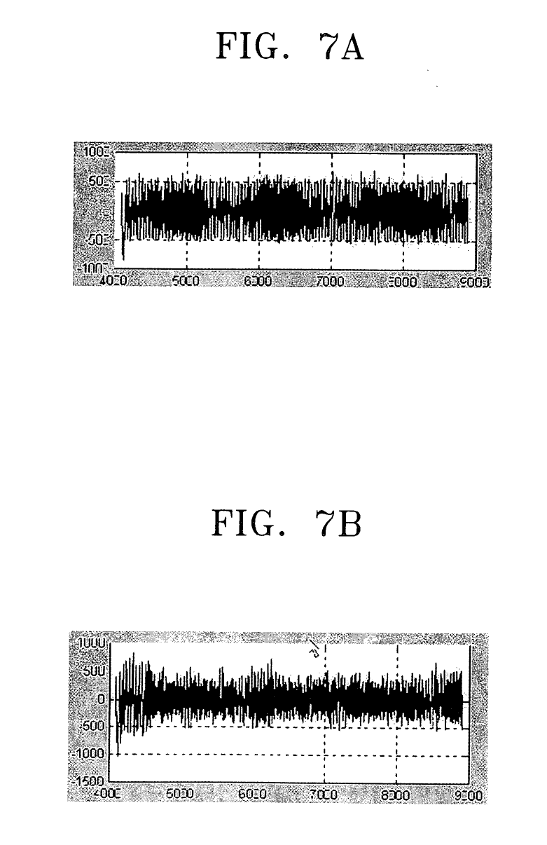

FIGS. 7A and 7B depict the speed of printing medium before and after using the method of FIG. 6, respectively.

FIG. 7A depicts the ripple error before the method of FIG. 6 is applied. As shown in FIG. 7A, the ripple error has a pattern which does not vary much along the y-axis. That is, the ripple error remains almost the same along the y-axis. In FIG. 7B, however, the ripple error is large at an initial stage, that is, where x coordinate value is smaller than 4500, and it is rapidly reduced thereafter. The ripple error was reduced because an optimal compensation delay amount was determined during the initial stage. After the optimal compensation delay amount was determined, the ripple error was reduced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for controlling a speed of a printing medium supplied to an image printing apparatus by a printing medium supply device, the apparatus comprising:
a compensation waveform storage unit for storing at least one compensation waveform used to compensate for at least a periodic ripple error of the speed, the periodic ripple error being obtained by analyzing positional information of the printing medium;
a compensation delay amount determiner for determining at least an amount of delay used in applying the compensation waveform to the printing medium supply device; and
a ripple compensator for applying at least the compensation waveform to the printing medium supply device with at least the determined amount of delay in order to compensate for the ripple error.

2. The apparatus of claim 1, wherein the compensation delay amount determiner determines an optimal compensation delay amount by using a self-learning algorithm that comprises a recursive method.

3. The apparatus of claim 2, wherein the compensation delay amount determiner comprises:
an error amount calculator for calculating an amount of cumulative error during one period of the ripple error;
a rate of change calculator for calculating a rate of change of an output of the error amount calculator; and
a delay amount learning portion for determining a result of an application of a learning constant to the output of the rate of change calculator as an updated compensation delay amount and delivering the updated compensation delay amount to the compensation waveform storage unit.

4. The apparatus of claim 3, wherein the compensation delay amount determiner further comprises a learning termination preventer for applying a given value to the rate of change calculated by the rate of change determiner when the rate of change remains unchanged, such that the compensation delay amount determiner continues the learning algorithm.

5. The apparatus of claim 1, wherein the compensation waveform storage unit stores the compensation waveform corresponding to one period of the ripple error, and further includes a modulo operator for periodically applying the compensation waveform to the printing medium supply device.

6. The apparatus of claim 5, wherein the compensation waveform storage unit determines the compensation waveform by analyzing frequency components of the ripple error and applying different weights to the analyzed frequency components.

7. The apparatus of claim 5, wherein the compensation waveform storage unit determines the compensation waveform by analyzing amplitude components of the ripple error and applying different weights to the analyzed amplitude components.

8. A method for controlling a speed of a printing medium supplied to an image printing apparatus by a printing medium supply device, the method comprising:
measuring a periodic ripple error in the printing medium speed by analyzing positional information of the printing medium;
determining a compensation waveform suitable for compensating for the ripple error;
determining an amount of compensation delay used when applying the compensation waveform to the printing medium supply device; and
compensating for the ripple error by applying the compensation waveform to the printing medium supply device with the determined amount of compensation delay.

9. The method of claim 8, wherein the determining of the compensation delay amount comprises determining an optimal compensation delay amount by using a self-learning algorithm that uses a recursive method.

10. The method of claim 9, wherein the determining of the optimal compensation delay amount comprises:
calculating a cumulative error amount during one period of the ripple error;
calculating a rate of change of the cumulative error amount; and
updating the compensation delay amount by multiplying the calculated rate of change by a learning constant.

11. The method of claim 10, wherein the determining of an optimal compensation delay amount further comprises applying a given value to the rate of change when the rate of change remains unchanged, such that the determining of the optimal compensation delay amount continues.

12. The method of claim 8, wherein the determining of the compensation waveform comprises:
storing the compensation waveform corresponding to one period of the ripple error; and
supplying the compensation waveform to the printing medium supply device periodically.

13. The method of claim 12, wherein the determining of the compensation waveform comprises analyzing frequency components of the ripple error and multiplying the analyzed frequency components by different weights.

14. The method of claim 12, wherein the determining of the compensation waveform comprises analyzing amplitude components of the ripple error and applying different weights to the analyzed amplitude components.
